(19) United States
(12) Patent Application Publication
(10) Pub. No.: US 2008/0043315 A1
(43) Pub. Date: Feb. 21, 2008

(54) High profile contacts for microelectromechanical systems

(76) Inventor: William J. Cummings, Millbrae, CA (US)

Correspondence Address: KNOBBE, MARTENS, OLSON & BEAR, LLP, 2040 MAIN STREET, FOURTEENTH FLOOR, IRVINE, CA, 92614, US

(21) Appl. No.: 11/504,319

(22) Filed: Aug. 15, 2006

(51) Int. Cl. G02B 26/00

(52) U.S. Cl. 359/290

(57) ABSTRACT

In certain embodiments, an interferometric modulator includes a substrate, a first electrode layer over the substrate, and a second electrode layer over the first electrode layer. The second electrode layer includes a first portion and a second portion. The first portion of the second electrode layer is configured to move between a relaxed position spaced away from the first electrode layer and an actuated position spaced closer to the first electrode layer than is the relaxed position. The second portion of the second electrode layer includes at least one electrical contact having an end extending generally away from the substrate.

### BACKGROUND

Microelectromechanical systems (MEMS) include micro mechanical elements, actuators, and electronics. Micromechanical elements may be created using deposition, etching, and/or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

In certain embodiments, an apparatus comprises a substrate, a first electrode layer over the substrate, and a second electrode layer over the first electrode layer. The second electrode layer comprises a first portion and a second portion. The first portion of the second electrode layer is configured to move between a relaxed position spaced away from the first electrode layer and an actuated position spaced closer to the first electrode layer than is the relaxed position. The second portion of the second electrode layer comprises at least one electrical contact having an end extending generally away from the substrate.

In certain embodiments, an apparatus comprises means for supporting the apparatus. The apparatus further comprises first means for applying a voltage to the apparatus. The first applying means is over the supporting means. The apparatus further comprises second means for applying a voltage to the apparatus. The second applying means is over the first applying means. The apparatus further comprises means for transmitting an electrical signal to the second applying means. The transmitting means has an end extending generally away from the supporting means. The transmitting means and the second applying means are both portions of a common layer. In some embodiments, the second applying means is configured to move a portion of the apparatus between a relaxed position spaced away from the first applying means and an actuated position spaced closer to the first applying means than is the relaxed position

In certain embodiments, a method of fabricating a microelectromechanical systems (MEMS) device comprises forming an electrode layer over a first portion of a substrate. The method further comprises forming a first sacrificial layer over the electrode layer. The method further comprises forming a second sacrificial layer over a second portion of the substrate. The method further comprises forming a metal layer over the first sacrificial layer and over the second sacrificial layer. The method further comprises removing the first sacrificial layer to create a gap between the metal layer and the electrode layer. The method further comprises removing the second sacrificial layer to allow a portion of the metal layer over the second portion of the substrate to bend away from the substrate.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIG. 5A illustrates one exemplary frame of display data in the 3×3 interferometric modulator display of FIG. 2.

FIG. 5B illustrates one exemplary timing diagram for row and column signals that may be used to write the frame of FIG. 5A.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 is a partial cross section of an embodiment of an array of interferometric modulators wherein an embodiment of an interferometric modulator within the array comprises an interconnect portion.

FIG. 9 is a cross section of an embodiment of an interferometric modulator having a bi-layer electrode layer.

FIG. 10 is a cross section of another embodiment of an interferometric modulator having a bi-layer electrode layer.

FIG. 11 is a partial top plan view of an embodiment of an array of interferometric modulators.

FIG. 12 is a perspective view of an embodiment of a driver chip being coupled with the interconnect portion of an embodiment of an interferometric modulator.

FIG. 13 schematically illustrates an embodiment of a display unit comprising an array of interferometric modulators.

FIG. 14 is a partial cross section of an embodiment of a partially fabricated MEMS device.

FIG. 15 is a partial cross section of an embodiment of a partially fabricated MEMS device.

FIG. 16 is a partial cross section of an embodiment of a partially fabricated MEMS device.

FIG. 17 is a partial cross section of an embodiment of a partially fabricated MEMS device.

FIG. 18 is a partial cross section of an embodiment of a partially fabricated MEMS device.

FIG. 19 is a partial cross section of an embodiment of a MEMS device.

FIG. 20 is a partial cross section of an embodiment of a MEMS device coupled with a driver chip.

FIG. 21 is a cross section of an embodiment of a partially fabricated MEMS device.

FIG. 22 is a cross section of an embodiment of a MEMS device.

### DETAILED DESCRIPTION OF PREFERRED EMBODIMENTS

The following detailed description is directed to certain specific embodiments of the invention. However, the invention can be embodied in a multitude of different ways. In this description, reference is made to the drawings wherein like parts are designated with like numerals throughout. As will be apparent from the following description, the embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

In certain embodiments, a MEMS device, such as an interferometric modulator, comprises a substrate and an electrode layer. In some embodiments, the electrode layer comprises one or more electrical contact portions that extend away from the substrate and are configured to contact the lead of a driver chip when the driver chip is mounted to the substrate. The electrical contacts can be sufficiently resilient to undergo relatively large displacements without breaking or being permanently deformed. In some embodiments, the one or more electrical contact portions are formed by a lithographic patterning process, so the contact portions have a relatively small width, as measured along a direction substantially parallel to the substrate, and are spaced relatively close together, as compared with the dimensions of spherical conductors that are disposed in anisotropic conductive films (ACFs). Accordingly, in various advantageous embodiments, the electrical contact portions can facilitate contact with contact leads of a driver chip and/or allow a higher density of interconnects or contact leads on the driver chip than is possible with systems that employ ACFs. Various methods for fabricating certain embodiments of a MEMS device having one or more electrical contact portions are described herein.

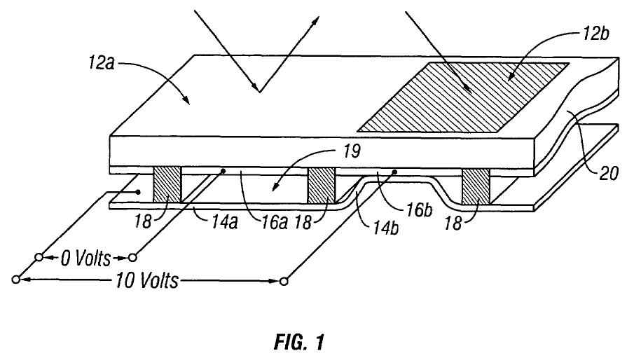

One interferometric modulator display embodiment comprising an interferometric MEMS display element is illustrated in FIG. 1. In these devices, the pixels are in either a bright or dark state. In the bright (“on” or “open”) state, the display element reflects a large portion of incident visible light to a user. When in the dark (“off” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical cavity with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent, and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device.

With no applied voltage, the cavity 19 remains between the movable reflective layer 14a and optical stack 16a, with the movable reflective layer 14a in a mechanically relaxed state, as illustrated by the pixel 12a in FIG. 1. However, when a potential difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by pixel 12b on the right in FIG. 1. The behavior is the same regardless of the polarity of the applied potential difference. In this way, row/column actuation that can control the reflective vs. non-reflective pixel states is analogous in many ways to that used in conventional LCD and other display technologies.

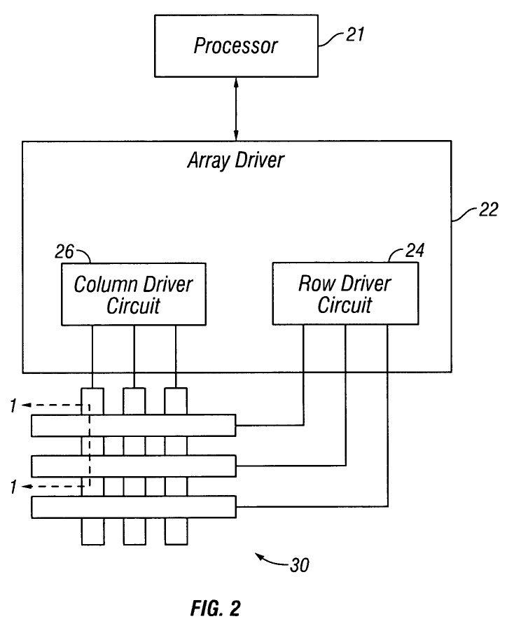

FIGS. 2 through 5B illustrate one exemplary process and system for using an array of interferometric modulators in a display application.

FIG. 2 is a system block diagram illustrating one embodiment of an electronic device that may incorporate aspects of the invention. In the exemplary embodiment, the electronic device includes a processor 21 which may be any general purpose single- or multi-chip microprocessor such as an ARM, Pentium®, Pentium II®, Pentium III®, Pentium IV®, Pentium® Pro, an 8051, a MIPS®, a Power PC®, an ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

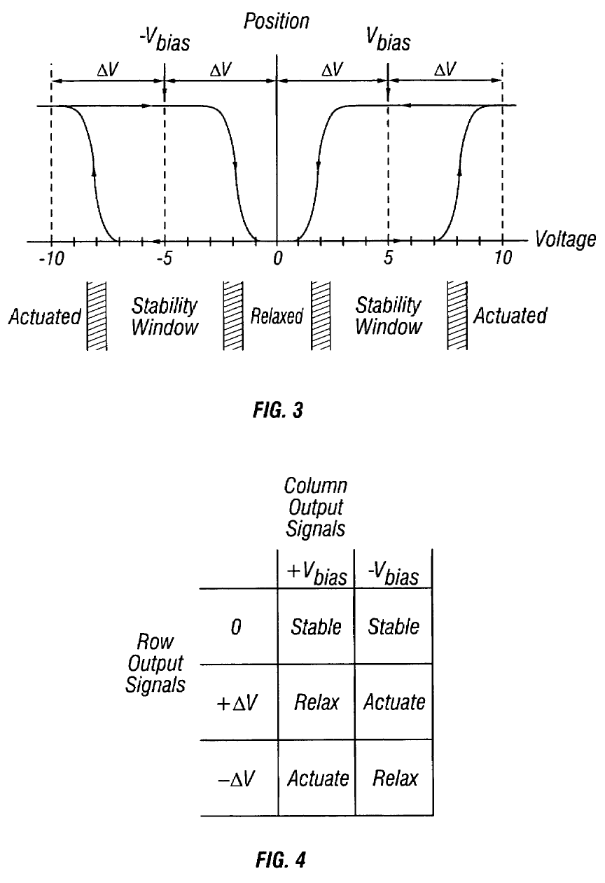

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. For MEMS interferometric modulators, the row/column actuation protocol may take advantage of a hysteresis property of these devices illustrated in FIG. 3. It may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. Thus, there exists a window of applied voltage, about 3 to 7 V in the example illustrated in FIG. 3, within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

In typical applications, a display frame may be created by asserting the set of column electrodes in accordance with the desired set of actuated pixels in the first row. A row pulse is then applied to the row 1 electrode, actuating the pixels corresponding to the asserted column lines. The asserted set of column electrodes is then changed to correspond to the desired set of actuated pixels in the second row. A pulse is then applied to the row 2 electrode, actuating the appropriate pixels in row 2 in accordance with the asserted column electrodes. The row 1 pixels are unaffected by the row 2 pulse, and remain in the state they were set to during the row 1 pulse. This may be repeated for the entire series of rows in a sequential fashion to produce the frame. Generally, the frames are refreshed and/or updated with new display data by continually repeating this process at some desired number of frames per second. A wide variety of protocols for driving row and column electrodes of pixel arrays to produce display frames are also well known and may be used in conjunction with the present invention.

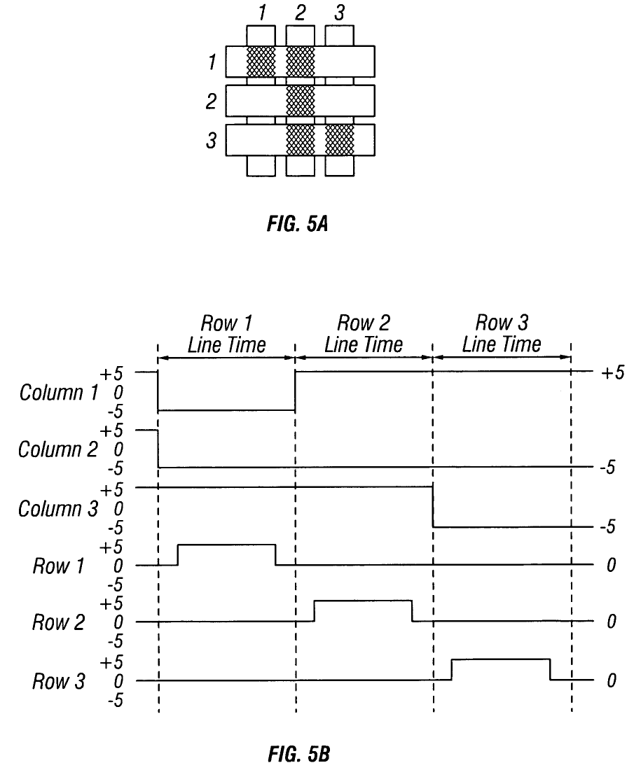

FIGS. 4, 5A, and 5B illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts, respectively. Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, it will be appreciated that voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any actuation voltage method can be used with the systems and methods described herein.

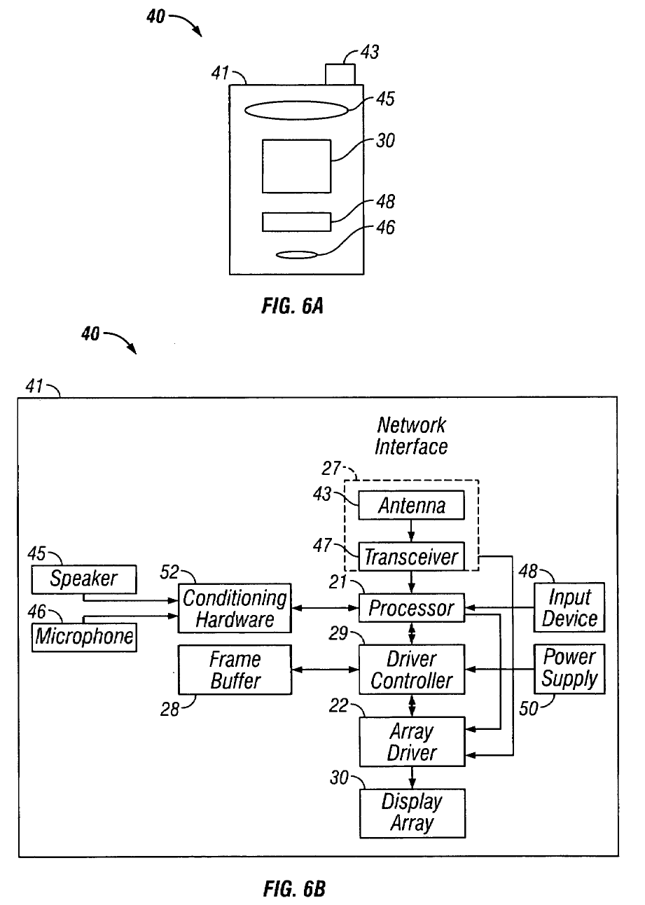

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes as are well known to those of skill in the art, including injection molding and vacuum forming. In addition, the housing 41 may be made from any of a variety of materials, including, but not limited to, plastic, metal, glass, rubber, and ceramic, or a combination thereof. In one embodiment, the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device, as is well known to those of skill in the art. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43, which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28 and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment, the network interface 27 may also have some processing capabilities to relieve requirements of the processor 21. The antenna 43 is any antenna known to those of skill in the art for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, or a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell including a plastic solar cell, and solar-cell paint. In another embodiment, power supply 50 is configured to receive power from a wall outlet.

In some embodiments, control programmability resides, as described above, in a driver controller which can be located in several places in the electronic display system. In some embodiments, control programmability resides in the array driver 22. Those of skill in the art will recognize that the above-described optimizations may be implemented in any number of hardware and/or software components and in various configurations.

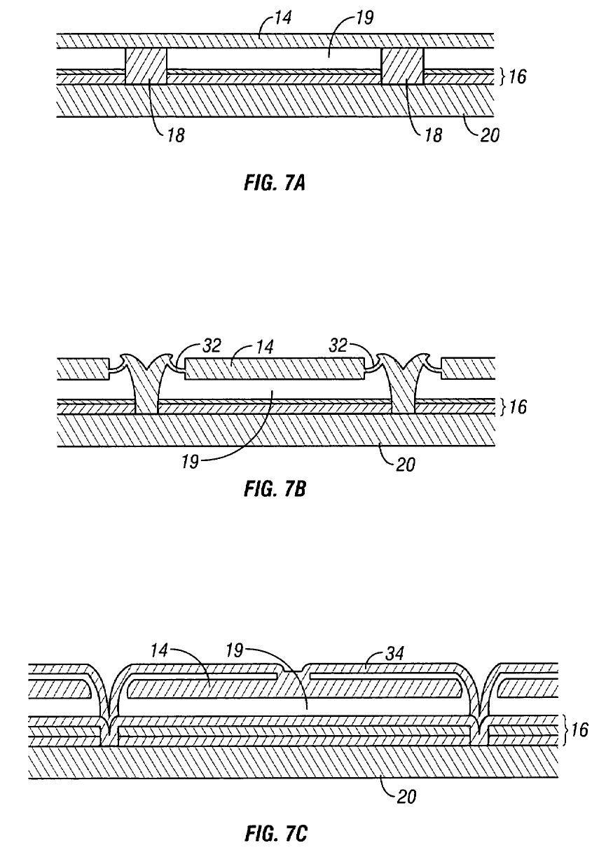

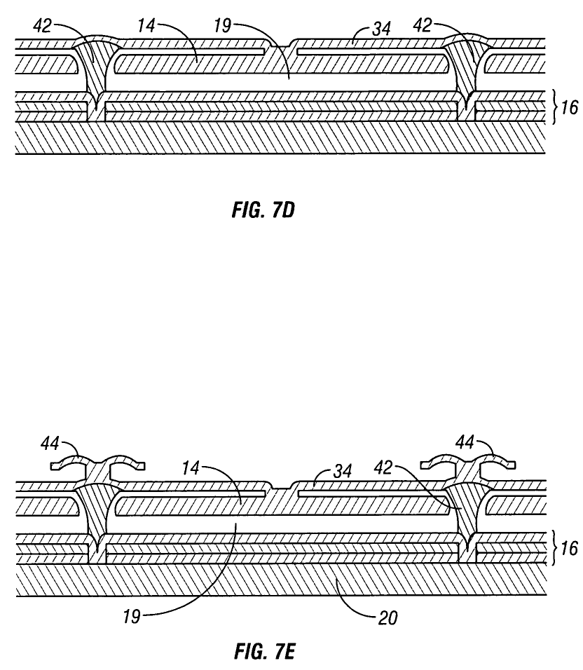

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 is attached to supports at the corners only, on tethers 32. In FIG. 7C, the moveable reflective layer 14 is suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the cavity, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C, as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. Such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

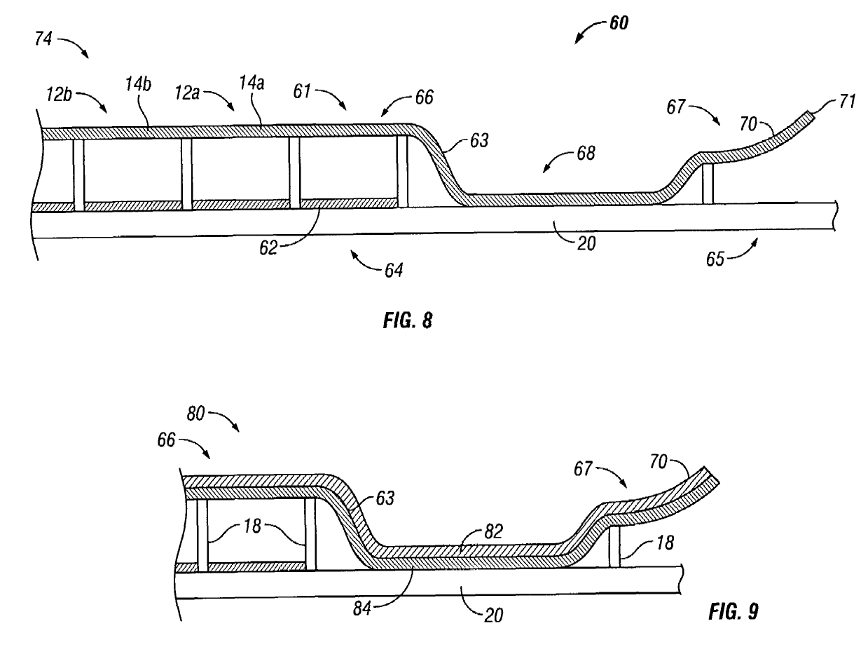

FIG. 8 depicts a cross-sectional view of an illustrative apparatus 60 comprising an array 74 of interferometric modulators 61 in accordance with certain embodiments described herein. In some embodiments, the apparatus 60 comprises the substrate 20, a first electrode layer 62 over the substrate 20, and a second electrode layer 63 over the first electrode layer 62. In certain embodiments, the second electrode layer 63 comprises an actuatable portion 66 and an interconnect portion 67. In some embodiments, the actuatable portion 66 is configured to move between a relaxed position spaced away from the first electrode layer 62 and an actuated position spaced closer to the first electrode layer 62 than is the relaxed position. In some embodiments, the interconnect portion 67 comprises at least one electrical contact having an end extending generally away from the substrate 20.

In certain embodiments, the first electrode layer 62 is formed over at least a first portion 64 of the substrate 20. In some embodiments, the first portion 64 of the substrate 20 is substantially transparent. The first electrode layer 62 can comprise a conductive material, such as indium tin oxide (ITO). In some embodiments, the first electrode layer 62 comprises additional materials, and comprises an optical stack 16a, 16b as described above.

The second electrode layer 63 can be positioned over the first electrode layer 62. In some embodiments, the second electrode layer 63 is also positioned over a second portion 65 of the substrate 20 that is not covered by the first electrode layer 62. In many embodiments, the second electrode layer 63 comprises a conductive material, such as metal. In various embodiments, the second electrode layer 63 comprises nickel, nickel alloys, aluminum, aluminum alloys, chromium, chromium alloys, silver, gold, oxide (such as silicon dioxide), or nitride (such as silicon nitride). In some embodiments, the second electrode layer 63 comprises combinations of materials. For example, in some embodiments the second electrode layer 63 comprises a stack including both conductive and substantially nonconductive materials. In some embodiments, the second electrode layer 63 comprises an actuatable portion 66, an interconnect portion 67, and an intermediate portion 68.

In some embodiments, the actuatable portion 66 of the second electrode layer 63 comprises a movable reflective layer 14a, 14b as described above. Accordingly, in some embodiments, the actuatable portion 66 is configured to move between a relaxed position and an actuated position. In some embodiments, when in the relaxed position, the actuatable portion 66 is spaced away from the first electrode layer 62. In further embodiments, when in the actuated position, the actuatable portion 66 is spaced closer to the first electrode layer 62 than is the relaxed position.

The interconnect portion 67 of the second electrode layer 63 can comprise one or more electrical contacts 70. In some embodiments, the one or more electrical contacts 70 are curved, bent, or otherwise shaped such that an end 71 thereof extends generally away from the substrate 20. In various embodiments, the distance between the end 71 and the substrate 20 is greater than about 5 microns, greater than about 10 microns, greater than about 15 microns, greater than about 20 microns, or greater than about 25 microns. In various other embodiments, the distance is less than about 25 microns, less than about 20 microns, less than about 15 microns, less than about 10 microns, or less than about 5 microns. In some embodiments, the distance is between about 5 microns and about 25 microns, between about 5 microns and about 15 microns, between about 10 microns and about 20 microns, or between about 15 microns and about 25 microns. In certain embodiments, the one or more electrical contacts 70 are substantially resilient. Accordingly, in some embodiments, the end 71 of a contact 70 is able to return to its original position and orientation after a minor displacement thereof toward or away from the substrate 20.

In certain embodiments, the intermediate portion 68 extends between the actuatable portion 66 and the interconnect portion 67. In some embodiments, the intermediate portion 68 comprises an electrical trace electrically coupled to the actuatable portion 66 and to the interconnect portion 67. The intermediate portion 68 can be located adjacent the substrate 20, and, in some embodiments, can be fastened or adhered thereto. In certain embodiments, the actuatable portion 66, the interconnect portion 67, and the intermediate portion 68 are integral with one another and all comprise the same material. In other embodiments, one or more of actuatable portion 66, the interconnect portion 67, and the intermediate portion 68 comprise a material different from that of the other portions.

With continued reference to FIG. 8, in certain embodiments, the second electrode layer 63 extends over an entire row or column of interferometric modulators 61 within the array 74. In some embodiments, one or more of the interferometric modulators 61 do not comprise an interconnect portion 67, such as the interferometric modulators 12a and 12b described above.

FIG. 9 depicts a cross-sectional view of an example interferometric modulator 80 compatible with certain embodiments described herein. As shown in FIG. 9, in some embodiments, the second electrode layer 63 of the interferometric modulator 80 comprises layers of different materials. The second electrode layer 63 can comprise a top layer 82 and a bottom layer 84. In some embodiments, the top layer 82 comprises a compressive material and the bottom layer 84 comprises a tensile material. As used herein, the term “compressive” is a broad term used in its ordinary sense and includes, without limitation, capable of compressing or contracting and tending to compress or contract, and the term “tensile” is a broad term used in its ordinary sense and includes, without limitation, capable of stretching and tending to stretch. The tensile material can have a tensile internal stress, and the compressive material can have a compressive internal stress.

As described below, in certain embodiments, the interconnect portion 67 of the second electrode layer 63 bends away from the substrate 20 during fabrication of the interferometric modulator 80 due to the different tensile properties of the top layer 82 and the bottom layer 84. For example, the top layer 82 can have a compressive internal stress that tends to contract the top layer 82 in a direction substantially parallel to the length of the interconnect portion 67, and the bottom layer 84 can have a tensile internal stress that tends to expand the interconnect portion 67 in a direction substantially parallel to the length of the interconnect portion 67. Accordingly, in some embodiments, the top and bottom layers 82, 84 cooperate to bend the interconnect portion 67 away from the substrate 20 along a plane substantially parallel to the length of the interconnect portion 67 and substantially perpendicular to the substrate 20.

In certain embodiments, the top layer 82 comprises aluminum, aluminum alloys, nickel, nickel alloys, chromium, chromium alloys, silver, gold, oxide (such as silicon dioxide), or nitride (such as silicon nitride). In further embodiments, the bottom layer 84 comprises nickel, nickel alloys, aluminum, aluminum alloys, chromium, chromium alloys, silver, gold, oxide (such as silicon dioxide), or nitride (such as silicon nitride). In certain embodiments, one of the top layer 82 and the bottom layer 84 comprises aluminum and the other of the top layer 82 and the bottom layer 84 comprises nickel. In some advantageous embodiments, the top layer 82 and the bottom layer 84 each comprises a conductive material.

In some embodiments, the second electrode layer 63 (including the interconnect portion 67) comprises more than two layers. In further embodiments, each of the more than two layers has different internal stress properties than the other layers. In other embodiments, the second electrode layer 63 (including the interconnect portion 67) comprises a single layer having a stress gradient along a thickness thereof. In some embodiments, the interconnect portion 67 of the second electrode layer 63 comprises one or more layers that have tensile properties different than one or more layers of the actuatable portion 66. In some embodiments, the interconnect portion 67 comprises a different number of layers than the actuatable portion 66. In various embodiments, the interconnect portions 67 just described can extend away from the substrate 20 due to differences in the internal stress along a thickness of the interconnect portion 67.

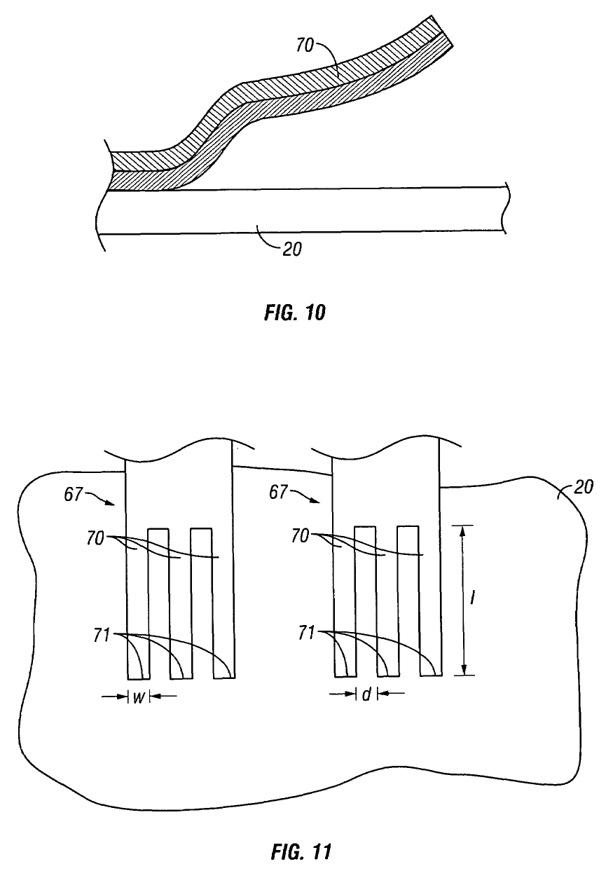

As illustrated by FIG. 9, in some embodiments, the second electrode layer 63 is formed (e.g., deposited) over a series of posts 18. Accordingly, in some embodiments, the one or more electrical contacts 70 are cantilevered from a post 18 over the substrate 20. In some embodiments, a relatively small portion of the one or more electrical contacts 70 is in contact with the post 18, which can permit the electrical contacts 70 to bend or extend away from the substrate 20 more easily than if a larger portion of the contacts 70 were in contact with the post 18. In some embodiments, the portion of the post 18 that contacts the electrical contacts 70 is rail-shaped and is substantially perpendicular to the substrate 20. In certain embodiments, the one or more electrical contacts 70 extend generally from the substrate 20, as illustrated in FIG. 10. Various methods for fabricating such embodiments are described below.

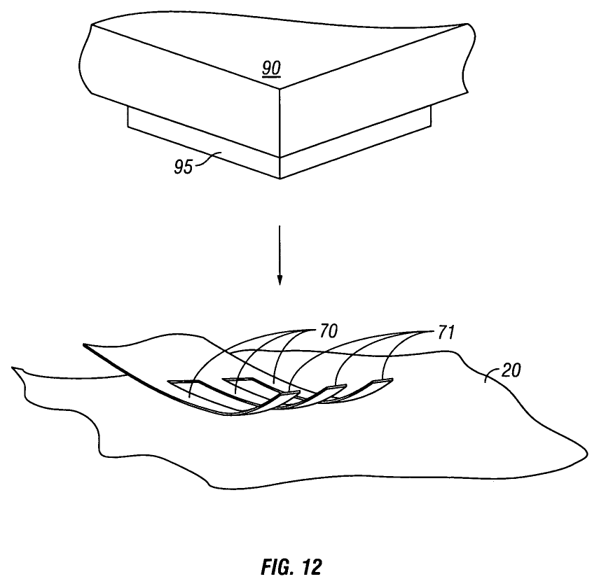

FIG. 11 depicts a top plan view of the interconnect portions 67 of two illustrative interferometric modulators. In the shown embodiment, each interconnect portion 67 comprises three electrical contacts 70. Other embodiments can comprise more or fewer interferometric modulators. In further embodiments, one or more interferometric modulators comprise more or fewer electrical contacts 70. In some embodiments, one or more interferometric modulators comprise only one electrical contact 70.

In certain embodiments, the electrical contacts 70 are lithographically formed (e.g., by a patterning process). As illustrated in FIG. 11, in certain embodiments, multiple electrical contacts 70 of a single interconnect portion 67 are fashioned substantially parallel to each other. In some embodiments, such parallel embodiments prevent undesirable contact between neighboring interconnect portions 67. In other embodiments, multiple electrical contacts 70 of a single interconnect portion 67 are angled with respect to each other. In some embodiments, the contacts 70 are angled away from each other and fan outward, and in other embodiments, the contacts 70 are angled toward each other and can touch and/or cross.

In various embodiments, the length l of an electrical contact 70, as measured along a direction substantially parallel to the substrate 20, is between about 10 microns and about 40 microns, between about 10 microns and about 30 microns, or between about 20 microns and about 40 microns. In some embodiments, the length l is greater than about 10 microns, greater than about 20 microns, greater than about 30 microns, or greater than about 40 microns. In other embodiments, the length l is less than about 40 microns, less than about 30 microns, less than about 20 microns, or less than about 10 microns. In certain embodiments, the length l is about 10 microns, about 20 microns, about 30 microns, or about 40 microns.

In various embodiments, the width w of an electrical contact 70, as measured along a direction substantially parallel to the substrate 20, is between about 3 microns and about 20 microns, between about 4 microns and about 15 microns, or between about 5 microns and about 10 microns. In some embodiments, the width w is greater than about 3 microns, greater than about 4 microns, greater than about 5 microns, or greater than about 10 microns. In other embodiments, the width w is less than about 20 microns, less than about 15 microns, less than about 10 microns, or less than about 5 microns. In certain embodiments, the width w is about 4 microns, about 5 microns, or about 6 microns. Accordingly, in some embodiments, the width w of an electrical contact 70 is smaller than the distance between the end 71 of the electrical contact 70 and the substrate 20.

In various embodiments, the distance d between the edges of adjacent electrical contacts 70, whether of the same or of adjacent interconnect portions 67, is between about 3 microns and about 20 microns, between about 4 microns and about 15 microns, or between about 5 microns and about 10 microns. In some embodiments, the distance d is greater than about 3 microns, greater than about 4 microns, greater than about 5 microns, or greater than about 10 microns. In other embodiments, the distance d is less than about 20 microns, less than about 15 microns, less than about 10 microns, or less than about 5 microns. In certain embodiments, the distance d is about 4 microns, about 5 microns, or about 6 microns.

Accordingly, in certain embodiments, the distance from the center of one electrical contact 70 to the center of an adjacent electrical contact 70 (i.e., the “pitch” of the electrical contacts 70) can be between about 6 microns and about 40 microns, between about 8 microns and about 30 microns, or between about 10 and about 20 microns; greater than about 6 microns, greater than about 8 microns, greater than about 10 microns, or greater than about 20 microns; less than about 40 microns, less than about 30 microns, less than about 20 microns, or less than about 10 microns; or, in some embodiments, about 8 microns, about 10 microns, about 15 microns, or about 20 microns.

FIG. 12 illustrates a driver chip 90 prior to being electrically coupled to the electrical contacts 70 of an interferometric modulator compatible with certain embodiments described herein. The driver chip 90 can be mounted on the substrate 20 in any suitable manner. In certain embodiments, the driver chip 90 comprises a lead 95 configured to contact one or more of the electrical contacts 70 when the driver chip 90 is mounted on the substrate 20. In some embodiments, the electrical contacts 70 are plated with soft metal, such as nickel, gold, silver, aluminum, copper, or platinum, which can help ensure a good contact between one or more electrical contacts 70 and the lead 95. In many embodiments, the driver chip 90 comprises multiple leads 95 for coupling with the electrical contacts 70 of multiple interferometric modulators. In further embodiments, the driver chip 90 comprises one or more leads 95 for coupling with portions of the interferometric modulators other than the electrical contacts 70, such as the first electrode layer.

In some embodiments, one or more leads 95 of the driver chip 90 comprise a standard bonding pad or gold bump suitable for use with anisotropic conductive films (ACFs). Accordingly, in certain embodiments, the leads 95 have a relatively large surface area and are spaced relatively far apart. ACFs generally comprise conducting spheres that are randomly distributed through a matrix. The surface area of a lead 95 and the surface area of a contact to which it is being connected are relatively large, as compared with the diameter of the conducting spheres, in order to ensure that one or more spheres will form an electrical connection between the lead 95 and the contact. Further, adjacent leads 95 are spaced relatively far apart, often by a distance greater than the diameter of the conducting spheres, in order to prevent undesirable cross connections among the leads 95. In some embodiments, the width of a lead 95 is substantially larger than the width w of an electrical contact 70. Accordingly, in some embodiments, two or more electrical contacts 70 of a single interferometric modulator are configured to make contact with a single lead 95. In certain of such embodiments, this redundancy ensures formation of an electrical contact between the lead 95 and the interferometric modulator.

In some embodiments, the leads 95 are positioned significantly closer to each other and/or have smaller surface areas than would be suitable for use with ACFs. Accordingly, the electrical contacts 70 can permit a higher density of interferometric modulators on the substrate 20 and/or leads 95 on the driver chip 90 than is possible with systems that employ ACFs. As noted above, in certain embodiments, the end 71 of an electrical contact 70 is spaced above the substrate 20 by a distance that is greater than the width w of the electrical contact 70. Accordingly, the height-to-width ratio of an electrical contact 70 can be much greater than the height-to-width ratio of an ACF conducting sphere, which, in many embodiments, is approximately 1:1. In some embodiments, a single electrical contact 70 is configured to couple with a single lead 95.

In certain embodiments, coupling the driver chip 90 with an electrical contact 70 bends or displaces the electrical contact 70 toward the substrate 20. In some embodiments, the electrical contact 70 is flexible, and can be sufficiently resilient to withstand relatively large displacements without permanently deforming and/or breaking. Accordingly, in some embodiments, the electrical contacts 70 are able to compensate for deviations among interferometric modulators, such as differences in the spacing of the tips 71 from the substrate 20. The electrical contacts 70 also can compensate for deviations in height along the surface of the substrate 20 or among various leads 95 of the driver chip 90.

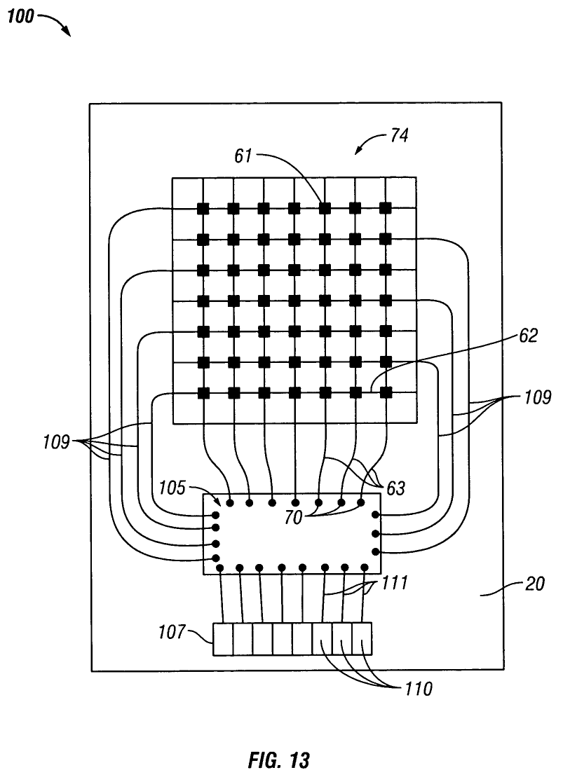

FIG. 13 schematically illustrates an embodiment of a display unit 100 compatible with certain embodiments described herein. In certain embodiments, the display unit 100 comprises the substrate 20, the interferometric modulator array 74, a chip mounting site 105, and a connector 107. In some embodiments, the display unit 100 can be mounted to or encased within the housing 41.

In some embodiments, each row of interferometric modulators 61 within the array 74 comprises a single first electrode layer 62 which extends among the interferometric modulators 61 of the row. In some embodiments, each first electrode layer 62 is part of a single optical stack 16 which extends among the interferometric modulators 61 of the row. In some embodiments, a separate trace 109 runs from each first electrode layer 62 of each optical stack 16 to the chip mounting site 105. In further embodiments, each second electrode layer 63 of the array 74 extends over a column of interferometric modulators 61 within the array 74, and terminates in one or more electrical connectors 70 at the chip mounting site 105.

In certain embodiments, the driver chip 90 (not shown) is mountable on the substrate 20 at the chip mounting site 105. In some embodiments, the driver chip 90 comprises a dedicated lead 95 for each trace 109 and a dedicated lead 95 for the one or more electrical connectors 70 of each interferometric modulator 60. In many embodiments, the driver chip 90 comprises the array driver 22. Accordingly, the interferometric modulator array 74 can function substantially the same as other arrays disclosed herein.

In certain embodiments, the connector 107 is configured to couple with a flexible cable (not shown) comprising one or more conductors for transmitting signals to the display unit 100. In some embodiments, the connector 107 comprises one or more connector ports 110. In some embodiments, a separate trace 111 extends from each connector port 110 to the chip mounting site 105.

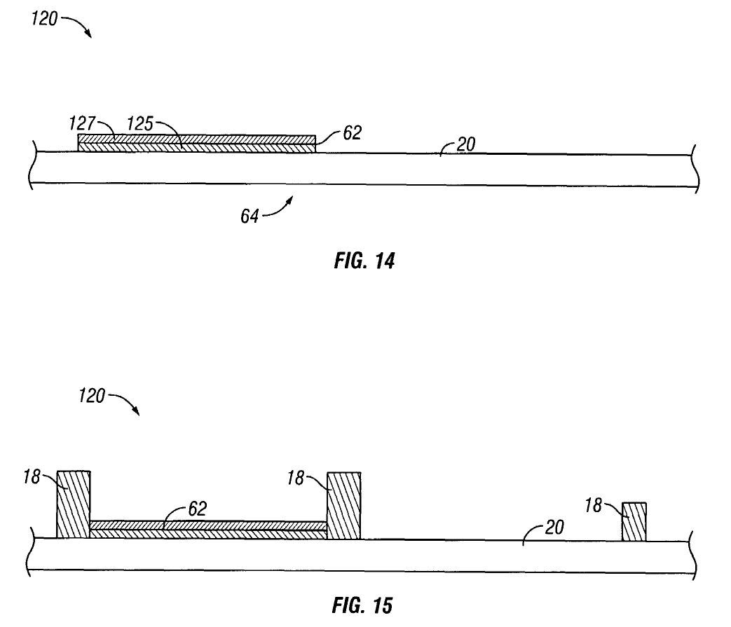

With reference to FIGS. 14-19, in certain embodiments, a method of fabricating a MEMS device 120, such as an interferometric modulator, comprises forming the first electrode layer 62 over the first portion 64 of the substrate 20. In some embodiments, the method comprises forming a first sacrificial layer 121 over the first electrode layer 62. In further embodiments, the method comprises forming a second sacrificial layer 122 over the second portion 65 of the substrate 20. In still further embodiments, the method comprises forming the second electrode layer 63 over the first sacrificial layer 121 and over the second sacrificial layer 122. In some embodiments, the method comprises removing the first sacrificial layer 121 to create the gap 19 between the second electrode layer 63 and the first electrode layer 62. In some embodiments, the method comprises removing the second sacrificial layer 122 to allow the interconnect portion 67 of the second electrode layer 63 over the second portion 65 of the substrate 20 to bend away from the substrate 20.

FIG. 14 illustrates the MEMS device 120 partially fabricated. In some embodiments, a method of fabricating the MEMS device 120 comprises forming the first electrode layer 62 over the first portion 64 of the substrate 20. As used herein, the term “forming” (and derivatives thereof) is a broad term used in its ordinary sense, and includes, without limitation, creating, designing, fashioning, molding, and depositing. In some embodiments, forming comprises one or more photolithographic processes. In certain embodiments, the first electrode layer 62 comprises multiple layers, such as an electrically conductive layer 125, a partially reflective layer 127, and/or a partially transparent layer. Accordingly, in some embodiments, forming the first electrode layer 62 comprises forming the electrically conductive layer 125 over the first portion 64 of the substrate 20 (which, as noted above, can be partially transparent in some embodiments). In further embodiments, forming the first electrode layer 62 comprises forming the partially reflective layer 127 over the electrically conductive layer 125. In other embodiments, the electrically conductive layer 125 is formed over the partially reflective layer 127.

In some embodiments, two or more MEMS devices 120 are included in a MEMS device array (not shown), such as the display array 30 (shown in FIG. 2) or the array 74 (shown in FIG. 13). In some embodiments, two or more first electrode layers 62 are formed. In further embodiments, the two or more first electrode layers 62 are formed concurrently. In some embodiments, the two or more first electrode layers 62 are arranged in parallel rows or columns.

With reference to FIG. 15, in some embodiments, a series of posts 18 is formed over the substrate 20. In certain embodiments, the posts 18 are formed in proximity (e.g., adjacent) to the first electrode layer 62. In other embodiments, the first electrode layer 62 is formed in proximity (e.g., adjacent) to the posts 18. In other embodiments, such as those depicted in FIGS. 7B and 7C, no posts 18 are formed over the substrate 20.

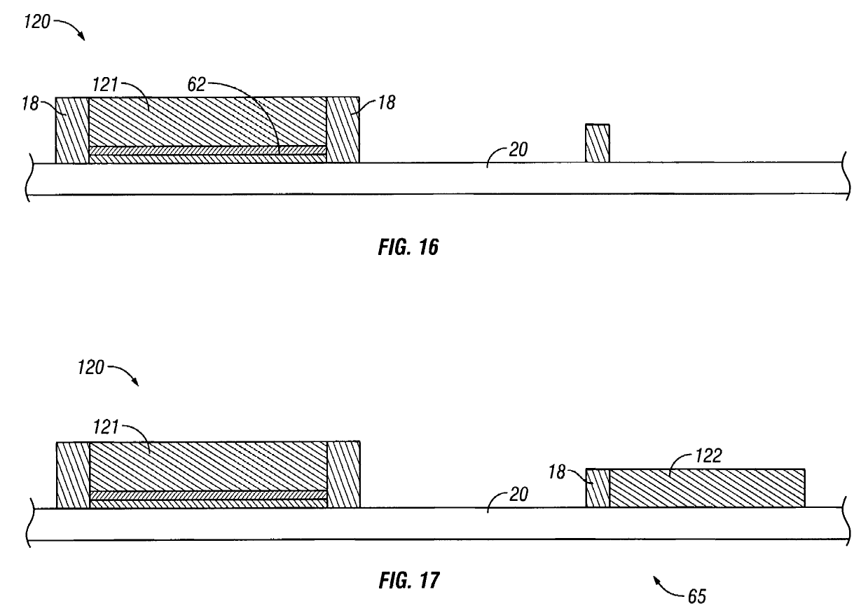

With reference to FIG. 16, in certain embodiments, the first sacrificial layer 121 is formed over the first electrode layer 62. In some embodiments, the first sacrificial layer 121 is formed in proximity (e.g., adjacent) to one or more posts 18. In other embodiments, after the first sacrificial layer 121 is deposited, a series of apertures are formed in the first sacrificial layer 121 and a layer of material is deposited to form the posts 18 in the apertures. In various embodiments, the first sacrificial layer 121 comprises molybdenum, tungsten, titanium, silicon, germanium, or other suitable materials, such as materials that can be removed using a selective etching process. In some embodiments, the sacrificial material is a photoresist such as can be used in microlithography processes.

With reference to FIG. 17, in some embodiments, the second sacrificial layer 122 is formed over the second portion 65 of the substrate 20. In some embodiments, the second sacrificial layer 122 is formed in proximity (e.g., adjacent) to one or more posts 18. In various embodiments, the second sacrificial layer 122 comprises molybdenum, tungsten, titanium, silicon, germanium, or other suitable materials, such as materials that can be removed using a selective etching process. In some embodiments, the sacrificial material is a photoresist such as can be used in microlithography processes.

In certain embodiments, the first sacrificial layer 121 and the second sacrificial layer 122 comprise the same material. In some embodiments, the first sacrificial layer 121 and the second sacrificial layer 122 each comprises molybdenum. In other embodiments, the first sacrificial layer 121 comprises a material different from the second sacrificial layer 122. In some embodiments, at least one of the first sacrificial layer 121 and the second sacrificial layer 122 comprises molybdenum and the other of the first sacrificial layer 121 and the second sacrificial layer 122 comprises a photoresistive material, such as a polymer or other material known in the art or yet to be devised.

In certain embodiments, forming the first sacrificial layer 121 and forming the second sacrificial layer 122 are performed concurrently. In other embodiments, forming the first sacrificial layer 121 and forming the second sacrificial layer 122 are performed separately.

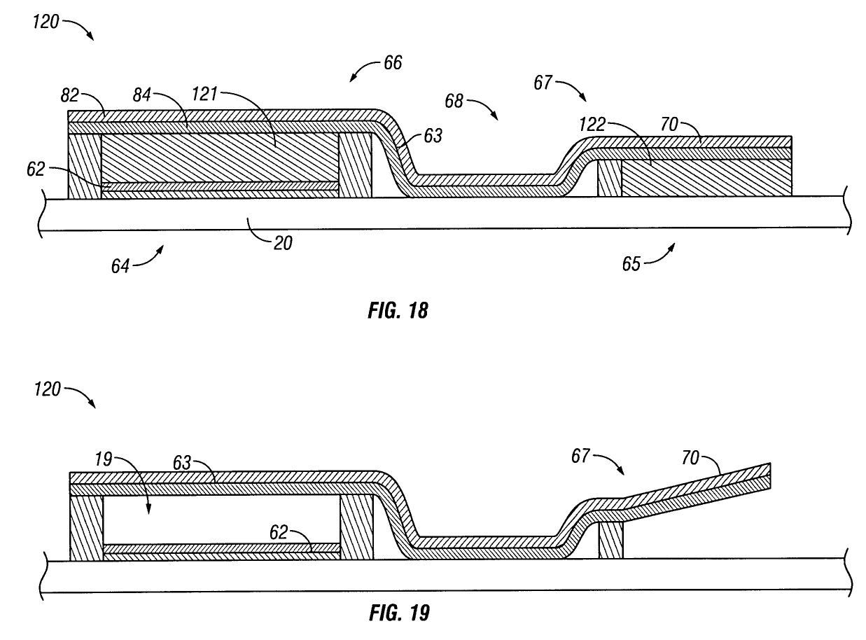

With reference to FIG. 18, in certain embodiments, the second electrode layer 63 is formed over the first sacrificial layer 121 and over the second sacrificial layer 122. In some embodiments, the second electrode layer 63 comprises the top layer 82 and the bottom layer 84. Accordingly, in some embodiments, the top layer 82 is formed over the bottom layer 84. In further embodiments, one or more additional layers are formed over the top layer 82.

In some embodiments, two or more MEMS devices 120 are included in the MEMS device array (not shown). In some embodiments, two or more second electrode layers 63 are formed. In further embodiments, the two or more second electrode layers 63 are formed concurrently.

As noted above, in some embodiments, the second electrode layer 63 comprises the actuatable portion 66, the interconnect portion 67, and the intermediate portion 68. In many embodiments, the portions 66, 67, 68 are formed concurrently. The portions 66, 67, 68 can each comprise the same material and can be integrally formed. In certain embodiments, the second electrode layer 63 comprises a unitary piece of material over the first portion 64 and the second portion 65 of the substrate 20. In other embodiments, one or more of the portions 66, 67, 68 are formed separately from one or more of the other portions 66, 67, 68. In some embodiments, one or more of the portions 66, 67, 68 comprise a material different from one or more of the other portions 66, 67, 68.

In certain embodiments, the actuatable portion 66 is formed over the first sacrificial layer 121. In further embodiments, the actuatable portion 66 is formed over the first sacrificial layer 121 and over one or more posts 18.

In some embodiments, two or more actuatable portions 66 are included in the MEMS device array (not shown). In certain embodiments, the two or more actuatable portions 66 are arranged in parallel rows or columns and, in some embodiments, are oriented orthogonally with respect to two or more parallel first electrode layers 62.

In certain embodiments, the interconnect portion 67 is formed over the second sacrificial layer 122. In some embodiments, the interconnect portion 67 is formed such that it comprises one or more electrical contacts 70.

In certain embodiments, the intermediate portion 68 is formed over the substrate 20. In some embodiments, the intermediate portion 68 is formed separately from the actuatable portion 66 and the interconnect portion 67. In some embodiments, the intermediate portion 68 comprises an electrical trace between the actuatable portion 67 and the interconnect portion 67.

With reference to FIG. 19, in certain embodiments, the first sacrificial layer 121 is removed to create the gap 19 between the second electrode layer 63 and the first electrode layer 62. As used herein, the term “remove” (and derivatives thereof) is a broad term used in its ordinary sense, and includes, without limitation, the withdrawal, elimination, extraction, or etching of the identified item. In certain embodiments, removing the first sacrificial layer 121 comprises exposing the first sacrificial layer 121 to xenon difluoride (XeF₂) gas. For example, in some embodiments, the first sacrificial layer 121 comprises molybdenum, which can effectively be removed via exposure to xenon difluoride gas.

In certain embodiments, the second sacrificial layer 122 is removed and at least a portion of the interconnect portion 67 of the second electrode layer 63 is allowed to bend away from the substrate 20. In certain embodiments, the one or more electrical contacts 70 bend away from the substrate 20. As discussed above, in some embodiments, the one or more electrical contacts 70 comprise one or more materials that, either alone or in combination, are biased to bend away from the substrate 20. In some embodiments, contact between the electrical contacts 70 and the second sacrificial layer 122, or an adhesive or other material thereon, is stronger than the bias of the electrical contacts 70 such that the electrical contacts 70 substantially conform to the shape of the surface of the second sacrificial layer 122. In certain of such embodiments, removal of the second sacrificial layer 122 permits the one or more electrical contacts 70 to bend or curve away from the substrate 20 under their natural bias.

In some embodiments, removing the second sacrificial layer 122 comprises exposing the second sacrificial layer 122 to xenon difluoride gas. In other embodiments, removing the second sacrificial layer 122 comprises exposing the second sacrificial layer 122 to wet or dry etching processes that are selective to the material of the second sacrificial layer 122. In some embodiments the sacrificial layer 122 comprises a polymer that can easily be removed by dry etching, such as by a plasma dry etch comprising O₂ gas, SF₆ gas, CH₄ gas, or N₂ gas or any suitable combination thereof.

In some embodiments, the first sacrificial layer 121 and the second sacrificial layer 122 comprise the same material and can be removed in the same manner. For example, in some embodiments, the first sacrificial layer 121 and the second sacrificial layer 122 each comprises molybdenum. Accordingly, in some embodiments, the first sacrificial layer 121 and the second sacrificial layer 122 are both removed via exposure to xenon difluoride gas.

In other embodiments, the first sacrificial layer 121 and the second sacrificial layer 122 comprise different materials and can be removed in different manners. For example, in some embodiments, the first sacrificial layer 121 comprises molybdenum and the second sacrificial layer 122 comprises a polymer or other material known in the art or yet to be devised. Accordingly, in some embodiments, the first sacrificial layer 121 is removed via exposure to xenon difluoride gas and the second sacrificial layer is removed via exposure to wet or dry etching processes that are selective to the material of the second sacrificial layer 122.

In some embodiments, removing the first sacrificial layer 121 and the second sacrificial layer 122 are performed concurrently. In other embodiments, removing the first sacrificial layer 121 and the second sacrificial layer 122 are performed separately. For example, in some embodiments, the first sacrificial layer 121 comprises molybdenum, which, as noted above, can be removed via exposure to xenon difloride gas, and the second layer 122 comprises a polymer or other material known in the art or yet to be devised that generally cannot be removed via exposure to xenon difluoride gas. In certain of such embodiments, the partially fabricated MEMS device 120 is exposed to xenon difluoride gas, which removes the first sacrificial layer 121 but not the second sacrificial layer 122, and then exposed to wet or dry etching processes that remove the second sacrificial layer 122.

In some embodiments, the method of fabricating the MEMS device 120 further comprises plating the one or more electrical contacts 70 with metal. In some embodiments, the contacts 70 already comprise metal, thus additional metal is added to the contacts 70 via plating. In some embodiments, the one or more electrical contacts 70 are plated with metal such as gold, nickel, silver, aluminum, copper, or platinum.

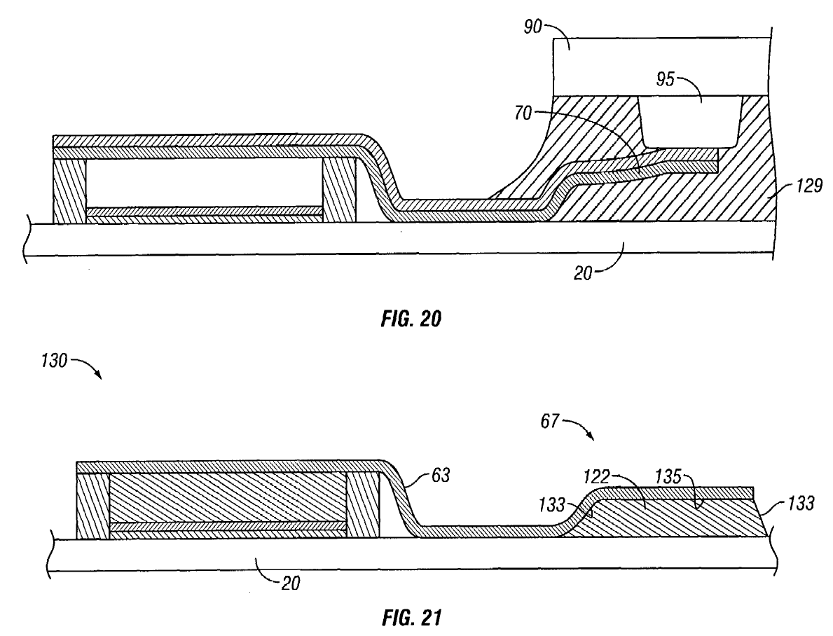

As illustrated in FIG. 20, in certain embodiments, the driver chip 90 is mounted to the substrate 20. In some embodiments, the driver chip 90 is contacted to the one or more electrical contacts 70. In further embodiments, the lead 95 of the driver chip 90 is contacted to the one or more electrical contacts 70.

In certain embodiments, once the second sacrificial layer 122 has been removed, the bent or curved electrical contacts 70 are susceptible to breaking due to humidity changes, vibrations, or other disruptions. In some embodiments, the risk of breaking is reduced with the driver chip 90 is mounted to the substrate. In some embodiments, a bonding agent 129, such as epoxy adhesive, substantially encases the electrical contacts 70, substantially reducing humidity fluctuations and substantially dampening vibrations. Accordingly, in some advantageous embodiments, removing the second sacrificial layer 122 is performed after removing the first sacrificial layer 121 and before mounting the driver chip 90 to the substrate 20. In some embodiments, removing the second sacrificial layer 122 is performed a relatively short time before mounting the driver chip 90 to the substrate 20. In various embodiments, removing the second sacrificial layer 122 is performed no more than about 30 seconds, about 60 seconds, about 2 minutes, about 5 minutes, about 10 minutes, about 30 minutes, or about 1 hour before mounting the driver chip 90 to the substrate 20. In some embodiments, removing the second sacrificial layer 122 is performed no less than about 30 minutes before mounting the driver chip 90 to the substrate 20.

In other advantageous embodiments, no additional processing phases are required to fabricate interferometric modulators comprising one or more electrical contacts 70, as compared with fabrication of certain embodiments of interferometric modulators that do not comprise electrical contacts 70. For example, some methods of fabricating certain embodiments of interferometric modulators that do not comprise electrical contacts 70 comprise forming a single sacrificial layer, forming a metal layer over the sacrificial layer, and removing the sacrificial layer. By comparison, some methods of fabricating interferometric modulators comprising electrical contacts 70, in accordance with certain embodiments described herein, comprise forming the first and second sacrificial layers 121, 122 concurrently, forming the second electrode layer 63 over the first and second sacrificial layers 121, 122 during a single processing phase, and removing the first and second sacrificial layers 121, 122 concurrently. As a result, certain embodiments comprising electrical contacts 70 take little or no additional time to fabricate. Accordingly, some of the advantages noted above, such as higher density interferometric modulator arrays, can be achieved without significantly lengthening processing times.

FIG. 21 depicts an embodiment of a partially fabricated MEMS device 130 in accordance with certain embodiments described herein. In some embodiments, the second sacrificial layer comprises one or more angled ends 133 and an interconnect support surface 135. In some embodiments, the interconnect support surface 135 is substantially parallel to a surface of the substrate 20. In some embodiments, the angled end 133 is configured to provide a smooth transition between a surface of the substrate 20 and the interconnect support surface 135.

In certain embodiments, a method of fabricating the MEMS device 130 comprises forming the second sacrificial layer 122 such that the second sacrificial layer 122 comprises one or more angled ends 133 and the interconnect support surface 135. As shown in FIG. 21, in some embodiments, the method further comprises forming the interconnect portion 67 of the second electrode layer 63 over the second sacrificial layer 122. In certain embodiments, the second electrode layer 63 contacts and is supported by the substrate 20, the angled end 133, and the interconnect support surface 135.

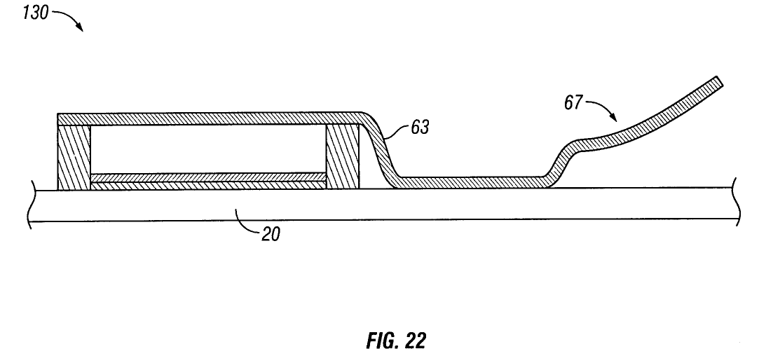

As shown in FIG. 22, in further embodiments, the method comprises removing the second sacrificial layer 122 to allow at least a portion of the interconnect portion 67 of the second electrode layer 63 to bend away from the substrate 20. Advantageously, in certain embodiments, fabricating the MEMS device 130 in the manner just described eliminates one or more processing steps, such as providing posts 18.

What is claimed is:

1. An apparatus comprising:
a substrate;
a first electrode layer over the substrate; and
a second electrode layer over the first electrode layer,
wherein the second electrode layer comprises a first portion and a second portion, the first portion of the second electrode layer configured to move between a relaxed position spaced away from the first electrode layer and an actuated position spaced closer to the first electrode layer than is the relaxed position, the second portion of the second electrode layer comprising at least one electrical contact having an end extending generally away from the substrate.

2. The apparatus of claim 1, wherein the at least one electrical contact has a width along a direction substantially parallel to the substrate that is smaller than a distance between the substrate and the end of the electrical contact.

3. The apparatus of claim 1, wherein the at least one electrical contact is cantilevered over the substrate.

4. The apparatus of claim 3, wherein the at least one electrical contact is cantilevered from a post.

5. The apparatus of claim 1, wherein the second electrode layer comprises aluminum or nickel.

6. The apparatus of claim 1, wherein the second electrode layer comprises a first layer and a second layer.

7. The apparatus of claim 6, wherein the first layer has a compressive internal stress and the second layer has a tensile internal stress, the first and second layers cooperating to bend the one or more electrical contacts away from the substrate.

8. The apparatus of claim 6, wherein at least one of the first layer and the second layer comprises nickel and the other of the first layer and the second layer comprises aluminum.

9. The apparatus of claim 1, wherein the at least one electrical contact is configured to contact a driver chip mountable on the substrate.

10. The apparatus of claim 9, wherein the at least one electrical contact comprises two or more electrical contacts that are configured to contact a single lead of the driver chip.

11. The apparatus of claim 10, wherein the two or more electrical contacts are substantially parallel to each other.

12. The apparatus of claim 1, wherein the at least one electrical contact is flexible.

13. The apparatus of claim 12, wherein the at least one electrical contact is configured to bend toward the substrate due to contact with an electrical lead.

14. The apparatus of claim 1, wherein the end of the at least one electrical contact is between about 5 microns and about 25 microns from the substrate.

15. The apparatus of claim 1, further comprising:
a display;
a processor that is configured to communicate with said display, said processor being configured to process image data; and
a memory device that is configured to communicate with said processor.

16. The apparatus of claim 15, further comprising a driver circuit configured to send at least one signal to the display.

17. The apparatus of claim 16, further comprising a controller configured to send at least a portion of the image data to the driver circuit.

18. The apparatus of claim 15, further comprising an image source module configured to send said image data to said processor.

19. The apparatus of claim 18, wherein the image source module comprises at least one of a receiver, transceiver, and transmitter.

20. The apparatus of claim 15, further comprising an input device configured to receive input data and to communicate said input data to said processor.

21. An apparatus comprising:
means for supporting the apparatus;
first means for applying a voltage to the apparatus, the first applying means over the supporting means;
second means for applying a voltage to the apparatus, the second applying means over the first applying means; and
means for transmitting an electrical signal to the second applying means, the transmitting means having an end extending generally away from the supporting means, wherein the transmitting means and the second applying means are both portions of a common layer.

22. The apparatus of claim 21, wherein the second applying means is configured to move a portion of the apparatus between a relaxed position spaced away from the first applying means and an actuated position spaced closer to the first applying means than is the relaxed position.

23. The apparatus of claim 21, wherein the supporting means comprises a substrate.

24. The apparatus of claim 21, wherein the first applying means comprises an electrode layer.

25. The apparatus of claim 21, wherein the second applying means comprises a first portion of an electrode layer and the transmitting means comprises a second portion of the electrode layer.

26. A method of fabricating a microelectromechanical systems (MEMS) device, comprising:
forming an electrode layer over a first portion of a substrate;
forming a first sacrificial layer over the electrode layer,
forming a second sacrificial layer over a second portion of the substrate;
forming a metal layer over the first sacrificial layer and over the second sacrificial layer;
removing the first sacrificial layer to create a gap between the metal layer and the electrode layer; and
removing the second sacrificial layer to allow a portion of the metal layer over the second portion of the substrate to bend away from the substrate.

27. The method of claim 26, wherein the second sacrificial layer comprises a material different from the first sacrificial layer.

28. The method of claim 27, wherein at least one of the first sacrificial layer and the second sacrificial layer comprises molybdenum and the other of the first sacrificial layer and the second sacrificial layer comprises a photoresist material.

29. The method of claim 26, wherein forming the first sacrificial layer and forming the second sacrificial layer are performed separately.

30. The method of claim 26, wherein forming the first sacrificial layer and forming the second sacrificial layer are performed concurrently.

31. The method of claim 26, wherein the removing the first sacrificial layer and removing the second sacrificial layer are performed separately.

32. The method of claim 31, wherein removing the second sacrificial layer is performed after removing the first sacrificial layer and before mounting a driver chip to the substrate.

33. The method of claim 26, wherein the removing the first sacrificial layer and removing the second sacrificial layer are performed concurrently.

34. The method of claim 26, wherein removing the first sacrificial layer comprises exposing the first sacrificial layer to xenon difluoride gas.

35. The method of claim 34, wherein removing the second sacrificial layer comprises exposing the second sacrificial layer to a plasma dry etch comprising O₂ gas, SF₆ gas, CH₄ gas, or N₂ gas, or a combination thereof.

36. The method of claim 26, wherein the metal layer is a unitary piece of material over the first portion and the second portion of the substrate.

37. The method of claim 26, further comprising contacting a driver chip to the portion of the metal layer bent away from the substrate.

38. The method of claim 37, wherein the portion of the metal layer bent away from the substrate comprises two or more electrical contacts.

39. The method of claim 26, wherein forming the metal layer comprises forming a first layer of the metal layer over a second layer of the metal layer.

40. The method of claim 26, further comprising plating additional metal on the portion of the metal layer bent away from the substrate.

41. A MEMS device fabricated by the method of claim 26.
